(19) United States
(12) Patent Application Publication
(10) Pub. No.: US 2025/0181476 A1
(43) Pub. Date: Jun. 5, 2025

(54) METHOD AND APPARATUS FOR APPROACH RECOMMENDATION WITH THRESHOLD OPTIMIZATION IN UNSUPERVISED ANOMALY DETECTION

(71) Applicant: Telefonaktiebolaget LM Ericsson (publ), Stockholm (SE)

(72) Inventors: Gautham Krishna Gudur, Chennai (IN); Adithya K, Chennai (IN); R Raaghul, Chennai (IN); Shrihari Vasudevan, Chennai Tamil Nadu (IN)

(73) Assignee: Telefonaktiebolaget LM Ericsson (publ), Stockholm (SE)

(21) Appl. No.: 18/842,886

(22) PCT Filed: Mar. 4, 2022
(86) PCT No.: PCT/IN2022/050194

§ 371 Date: Aug. 30, 2024

(51) Int. Cl. G06F 11/34; G06F 11/07

(52) U.S. Cl. CPC G06F 11/3452; G06F 11/0754; G06F 2201/81

(57) ABSTRACT

A computer-implemented method and apparatus for unsupervised anomaly detection is provided. The method includes identifying one or more unsupervised anomaly detection approaches, wherein cach anomaly detection approach identified includes an anomaly detection algorithm and a corresponding threshold parameter value; and receiving a set of data. The method further includes, for the identified anomaly detection approaches, applying a statistical method including: sampling over the identified anomaly detection approaches to obtain a prior probability distribution; obtaining an input of anomalies and non-anomalies for at least a portion of the received set of data; obtaining a post probability distribution over the identified anomaly detection approaches based on the obtained input, wherein the post probability distribution updates the prior probability distribution; and determining whether a first stopping criterion is met and, if the first stopping criterion is not met, reapplying the statistical method. The method further includes recommending, based on the applied statistical method, one or more of the anomaly detection approaches. The method further includes for each of the one or more recommended anomaly detection approaches, applying a dynamic threshold optimization method including: comparing detected anomalies and non-anomalies with the obtained anomalies and non-anomalies; varying the corresponding threshold parameter value based on said comparison, to obtain an optimal threshold parameter value; and determining whether a second stopping criterion is met and, if the second stopping criterion is not met, reapplying the dynamic threshold optimization method. The method further includes identifying, for each of the one or more recommended anomaly detection approaches, the optimal threshold parameter value obtained. The apparatus includes processing circuitry and a memory containing instructions executable by the processing circuitry, whereby the apparatus is operative to perform the method for unsupervised anomaly detection.

### TECHNICAL FIELD

Disclosed are embodiments related to a method and apparatus for unsupervised anomaly detection using a statistical framework for recommending anomaly detection approaches and dynamically selecting optimal threshold parameter values for the recommended approaches.

### BACKGROUND

Anomaly Detection (AD) is a process of identifying unexpected items or events in data sets. From a statistical view, assuming there is a distribution of events, anomalies are considered as unlikely events with respect to a defined threshold. There are also event-oriented views of anomalies, as there are anomalous events that have some unexpected, and typically negative effects on the processes of interest. In the past few years, machine learning has led to major breakthroughs in various areas related to automation and digitalization tasks, and anomaly detection plays an instrumental role in such tasks.

There have been multiple anomaly detection frameworks conventionally with a rich literature of supervised, unsupervised, and semi-supervised algorithms. See, e.g., Zhao, Y., Nasrullah, Z. and Li, Z., 2019. Pyod: A python toolbox for scalable outlier detection. Journal of machine learning research (JMLR), 20(96), pp.1-7. In general, anomaly is a domain/business specific definition, which evolves over time depending on changes in data distributions, geographical constraints, business contexts, and many more. This makes anomaly detection in any industry a cumbersome task, and requires extensive human expertise and domain knowledge in current frameworks.

Most of the success in anomaly detection systems in telecommunication stems from collecting and processing huge volumes of data in suitable environments. Multiple anomaly detection systems exist which have been successfully deployed across a myriad of telecommunication use cases like identifying anomalies in resource utilization in a telecommunication network, identifying operational network issues using Quality of Experience (QoE), Quality of Service (QoS) and other Key Performance Indicators (KPIs). With such anomaly detection systems, preventive and corrective measures could be taken proactively.

There have been multiple anomaly detection algorithms across various frameworks and settings as mentioned above. However, choosing the necessary algorithms with appropriate threshold parameters for the given data becomes a harder problem. The problem at hand is two-fold-first, choosing the anomaly detection algorithms that best fit the data; second, optimizing the right threshold for the recommended algorithms

Conventionally, the nature of data evolves over time depending on multiple factors like geographical constraints, business contexts, behavioral changes, and many more. Also, anomalies can broadly be classified as point, contextual and collective anomalies. Moreover, most anomaly detection systems in real-time are inherently unlabeled, thereby making them unsupervised in nature. These challenges make identifying all such anomalies a tedious process and requires experts well-versed in their respective domains. See, e.g., Chandola, V., Banerjee, A. and Kumar, V., 2009. Anomaly detection: A survey. ACM computing surveys (CSUR), 41(3), pp.1-58.

### SUMMARY

Approach recommendation in anomaly detection systems requires careful selection over all possible sets of relevant algorithms. Moreover, finding a common metric for evaluation and effective comparison of these algorithms is hard, due to their unsupervised nature and requires context of the problem. Hence, a robust framework which can be incorporated in the existing anomaly detection systems becomes necessary to recommend the best algorithms for the given data.

Once the best fit approaches/algorithms have been identified based on the nature of data, the corresponding threshold parameters of the chosen algorithms need to be fine-tuned. Most anomaly detection systems consist of a scoring function to identify anomalies governed by a corresponding threshold parameter. Due to the evolving nature of data, the corresponding threshold used during training might not be applicable over time after deployment. To overcome this, the corresponding threshold parameter has to be fine-tuned dynamically to adapt to the changes in data.

A unified framework for human-augmented approach recommendation in any given anomaly detection system makes it more convenient for the end-user to identify the appropriate algorithms for the problem at hand. Once the right anomaly detection algorithms are chosen, dynamic threshold fine-tuning is performed to select the optimal threshold values in an unsupervised setting with partial feedback. This makes the model easier to adapt to changes in real-world data distributions and concept drifts, when deployed in an online scenario.

Some of the embodiments disclosed herein solve the approach recommendation problem for unsupervised anomaly detection by using, in some embodiments, a human-augmented Bayesian inference framework with active learning user feedback.

Some of the embodiments disclosed herein solve the optimal threshold identification problem by using, in some embodiments, continuous optimization or contextual bandit.

Some of the embodiments disclosed herein provide a single end-to-end unsupervised anomaly detection method and apparatus with efficient approach recommendation and threshold optimization together which operate in synchronicity with human-augmented active learning user feedback.

Some of the embodiments disclosed herein address the drawbacks associated with the current approaches by providing a novel anomaly detection method and apparatus in both supervised and unsupervised settings to solve automated and efficient approach recommendation and dynamic threshold optimization simultaneously. In some embodiments, the method and apparatus jointly utilizes Bayesian inference, active learning and human augmentation coupled with either continuous threshold optimization or contextual bandits.

Some of the embodiments of the disclosed anomaly detection method and apparatus handle unsupervised anomaly detection without labels which is common in any industry, particularly telecommunication, and holds good for any type of anomalies like point/collective/contextual anomalies. Some of the embodiments of the disclosed anomaly detection method and apparatus recommend appropriate anomaly detection algorithms/approaches for the given data using a novel Bayesian inference framework.

Some of the embodiments of the disclosed anomaly detection method and apparatus dynamically select the optimal threshold for any given anomaly detection algorithm. Some of the embodiments of the disclosed anomaly detection method and apparatus reduce the time taken (user effort) for querying optimal data points (anomalies) from the domain expert using active learning.

Some of the embodiments of the disclosed anomaly detection method and apparatus can incorporate domain knowledge from experts in the form of priors resulting in faster convergence to a good recommendation. Some of the embodiments of the disclosed anomaly detection method and apparatus reduce the need for multiple manual iterations and continuous monitoring for changing and evolving characteristics in data. Some of the embodiments of the disclosed anomaly detection method and apparatus enable 1) data efficient, 2) effort efficient, and 3) time efficient unsupervised anomaly detection.

In some embodiments, the method and apparatus may handle unsupervised anomaly detection approaches. The method and apparatus may be able to handle any type of anomalies such as point/collective/contextual anomalies making it ideal for any industry, particularly telecommunication. The method and apparatus may recommend appropriate anomaly detection approaches for the given data using a novel Bayesian inference framework. The method and apparatus may also dynamically select the optimal threshold for any given anomaly detection algorithm. Thus, the method and apparatus may reduce the time taken (user effort) for querying optimal data points (anomalies) from the domain expert using active learning.

In a first aspect, a computer-implemented method for unsupervised anomaly detection is provided. The method includes identifying one or more unsupervised anomaly detection approaches, wherein each anomaly detection approach identified includes an anomaly detection algorithm and a corresponding threshold parameter value; and receiving a set of data. The method further includes, for the identified anomaly detection approaches, applying a statistical method including: sampling over the identified anomaly detection approaches to obtain a prior probability distribution; obtaining an input of anomalies and non-anomalies for at least a portion of the received set of data; obtaining a post probability distribution over the identified anomaly detection approaches based on the obtained input, wherein the post probability distribution updates the prior probability distribution; and determining whether a first stopping criterion is met and, if the first stopping criterion is not met, reapplying the statistical method. The method further includes recommending, based on the applied statistical method, one or more of the anomaly detection approaches. The method further includes for each of the one or more recommended anomaly detection approaches, applying a dynamic threshold optimization method including: comparing detected anomalies and non-anomalies with the obtained anomalies and non-anomalies; varying the corresponding threshold parameter value based on said comparison, to obtain an optimal threshold parameter value; and determining whether a second stopping criterion is met and, if the second stopping criterion is not met, reapplying the dynamic threshold optimization method. The method further includes identifying, for each of the one or more recommended anomaly detection approaches, the optimal threshold parameter value obtained.

In some embodiments, the method further comprises using the one or more recommended anomaly detection approaches, each including the recommended anomaly detection algorithm with corresponding optimal threshold parameter value, to detect an anomaly. In some embodiments, the one or more recommended anomaly detection approaches are used for detecting anomalous behavior in a telecommunications network.

In some embodiments, the received set of data relates to a key performance indicator (KPI). In some embodiments, the key performance indicator relates to quality of service (QoS). In some embodiments, the key performance indicator relates to quality of reception (QoR).

In some embodiments, the statistical method follows Bayesian inference. In some embodiments, the prior probability distribution is a Bayesian prior. In some embodiments, the post probability distribution is a Bayesian posterior. In some embodiments, the prior probability distribution follows one of: a Dirichlet distribution, a Bernoulli distribution, a Nominal distribution, a Binomial distribution, a Multinomial distribution, a Uniform distribution, a T-distribution, a Beta distribution, a Beta-binominal distribution, a Poisson distribution, and a Gaussian distribution.

In some embodiments, if known characteristics of the received set of data are available, the prior probability distribution is based on the known characteristics, and if not available, the prior probability distribution is uniform. In some embodiments, the known characteristics of the received set of data includes at least one of: point type anomalies, contextual type anomalies, and collective type anomalies.

In some embodiments, the prior probability distribution is based on a user input. In some embodiments, the input of anomalies and non-anomalies obtained is user-generated. In some embodiments, an active learning acquisition function is used for obtaining the input of anomalies and non-anomalies.

In some embodiments, the post probability distribution follows one of: a Dirichlet distribution, a Bernoulli distribution, a Nominal distribution, a Binomial distribution, a Multinomial distribution, a Uniform distribution, a T-distribution, a Beta distribution, a Beta-binominal distribution, a Poisson distribution, and a Gaussian distribution.

In some embodiments, the post probability distribution is updated based on the prior probability distribution and the input on anomalies and non-anomalies obtained.

In some embodiments, the first stopping criterion is based on a predetermined number of iterations after which m anomaly detection approaches are recommended. In some embodiments, the first stopping criterion is based on m anomaly detection approaches whose post probability values are above a first stopping threshold, and the said m anomaly detection approaches are recommended.

In some embodiments, the dynamic threshold optimization method follows a continuous optimization. In some embodiments, the dynamic threshold optimization method further includes: obtaining a second input of anomalies and non-anomalies for at least a portion of the received set of data; and comparing detected anomalies and non-anomalies with the obtained second input of anomalies and non-anomalies. In some embodiments, one or more false positives and false negatives are obtained by said comparison. In some embodiments, the dynamic threshold optimization method further includes: varying the corresponding threshold parameter value based on a percentage deviation as compared to the false positives and false negatives obtained. In some embodiments, the corresponding threshold parameter value is increased if there are more false negatives than false positives. In some embodiments, the corresponding threshold parameter value is decreased if there are more false positives than false negatives.

In some embodiments, the second stopping criterion is based on a change in corresponding threshold parameter value being lower than a second stopping threshold.

In some embodiments, the dynamic threshold optimization method follows a contextual bandit. In some embodiments, a high reward is received and no change is made to the corresponding threshold parameter value if the number of both false positives and false negatives is low. In some embodiments, a low reward is received and the corresponding threshold parameter value is increased if the number of false negatives is greater than the number of false positives. In some embodiments, a low reward is received and the corresponding threshold parameter value is decreased if the number of false positives is greater than the number of false negatives. In some embodiments, a high reward is received and the corresponding threshold parameter value is unchanged if the number of both false positives and false negatives is high.

In some embodiments, the received set of data uses an optimal window size if there are a high number of both false positives and false negatives.

In some embodiments, one or more anomaly detection approaches are switched to non-linear methods if there are a high number of both false positives and false negatives.

According to a second aspect, an apparatus is provided. The apparatus includes processing circuitry and a memory containing instructions executable by the processing circuitry that causes the apparatus to perform the method of any one of the embodiments of the first aspect.

According to a third aspect, a computer program is provided. The computer program includes instructions which when executed by processing circuitry causes the processing circuitry to perform the method of any one of the embodiments of the first aspect.

According to a fourth aspect, a carrier is provided. The carrier contains the computer program of the fourth aspect and is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 is block diagram of an apparatus according to some embodiments.

FIG. 2A is a block diagram illustrating a computer-implemented method for unsupervised anomaly detection according to some embodiments.

FIG. 2B is a block diagram illustrating a computer-implemented method for unsupervised anomaly detection according to some embodiments.

FIG. 3 is a block diagram illustrating a method for unsupervised anomaly detection using a statistical method for recommending anomaly detection approaches and dynamically selecting optimal threshold parameter values for the recommended approaches according to some embodiments.

FIG. 4A is a block diagram illustrating a method for unsupervised anomaly detection using a statistical method for recommending anomaly detection approaches according to some embodiments.

FIG. 4B is a block diagram illustrating a method for unsupervised anomaly detection using a statistical method for recommending anomaly detection approaches according to some embodiments.

FIG. 5A is a block diagram illustrating a method for unsupervised anomaly detection including dynamically selecting optimal threshold parameter values for the recommended approaches according to some embodiments.

FIG. 5B is a block diagram illustrating a method for unsupervised anomaly detection including dynamically selecting optimal threshold parameter values for the recommended approaches according to some embodiments.

FIG. 6 is a block diagram illustrating an apparatus according to some embodiments.

FIG. 7 is a block diagram illustrating an apparatus according to some embodiments.

### DETAILED DESCRIPTION

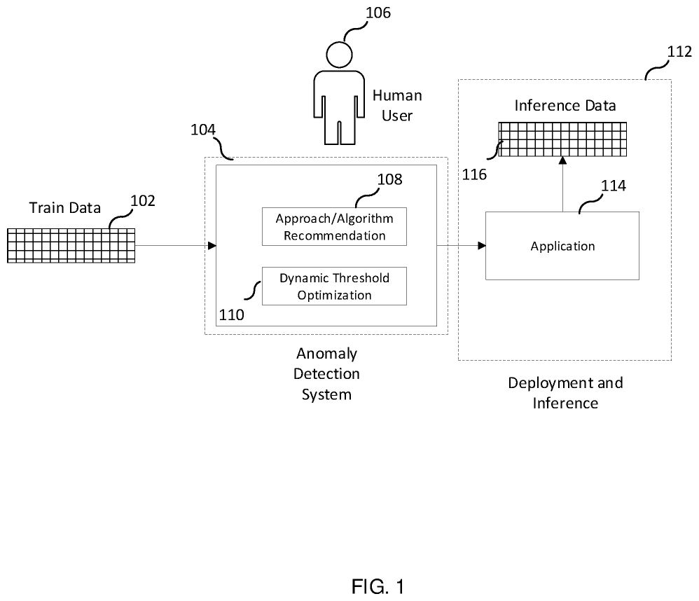

FIG. 1 is block diagram of an apparatus according to some embodiments. At 102, an apparatus may start with a set of data. Within the set of data, various types of anomalies may be present. For example, the data may contain point anomalies, contextual anomalies or collective anomalies. Point anomalies are individual data instances which are anomalous with respect to the rest of the data. Contextual anomalies are data instances which are anomalous only in a specific context. For example, data appearing may be anomalous if appearing at a certain time such as month or year. Collective anomalies are data instances which are anomalous with respect to the entire data set.

Depending on the type of anomalies, different anomaly detection algorithms are required. For example, Table 1 illustrates exemplary anomaly detection algorithms that could be employed to detect anomalies.

| Algorithm | Threshold parameter |
|---|---|
| Isolation forest | Contamination parameter |
| Z-score | z-value |
| Interquartile Range (IQR) | Scale |
| H-DBSCAN | Contamination parameter |
| Local Outlier Factor | Contamination parameter |
| Deep Autoencoders | Contamination parameter |

Anomaly detection systems must be flexible enough to cater to all types of anomalies. Some anomaly detection systems may be employed in supervised settings when received set of labels are present. Compared to supervised detection, unsupervised anomaly detection is more challenging as the system must identify anomalies without the received set of labels present.

To remedy this, an anomaly detection apparatus 104 may employed. A set of data 102 may be transferred to the anomaly detection apparatus 104. In some embodiments, a user 106 may provide inputs. The inputs may identify anomalies and non-anomalies within the set of data. The anomaly detection apparatus 104 may also identify one or more unsupervised anomaly detection approaches. The anomaly detection approaches may comprise of anomaly detection algorithms with corresponding threshold parameter values for detecting anomalies.

The anomaly detection apparatus 104 may employ a statistical method for approach recommendation 108. In some embodiments, the statistical method 108 may include anomaly detection approaches processing the set of data 102 in order to detect anomalies and non-anomalies. The statistical method 108 may optionally compare inputs received from the user 106 to the anomalies and non-anomalies detected by the anomaly detection approaches. The statistical method 108 may recommend anomaly detection approaches based on this comparison. In further embodiments, the statistical method 108 may sample over the anomaly detection approaches to obtain a prior probability distribution for each approach. A post probability distribution may be updated based on the prior probability distribution and optionally using the input from the user 106. The statistical method 108 may recommend anomaly detection approaches based on the post probability distribution generated by the statistical method.

The apparatus 104 may update the corresponding threshold parameter values for the recommended approaches using the dynamic threshold optimization method 110. The dynamic threshold optimization method 110 may update the corresponding threshold parameter values for the recommended approaches based on the comparison of the detected algorithms and the input received from the user 106. In some embodiments, the dynamic threshold optimization method 110 may use continuous optimization to vary the corresponding threshold parameter value. In other embodiments, the dynamic threshold optimization method 110 may vary the corresponding threshold parameter value using a reinforcement learning method such as a contextual bandit.

The apparatus 104 may operate the statistical method 108 and dynamic threshold optimization method 110 in parallel. For example, in the first iteration the dynamic threshold optimization method 110 may vary the corresponding threshold parameter values for all of the identified anomaly detection approaches. The statistical method 108 may use the updated corresponding threshold parameter values to more accurately detect anomalies and non-anomalies with the identified anomaly detection approaches. The statistical method 108 recommends the anomaly detection approaches based on this more accurate detection. In further embodiments, the recommended anomaly detection approaches may have their corresponding threshold parameter values varied again by the dynamic threshold optimization method 110. A deployment and inference apparatus 112 may use the recommended approaches with the optimized threshold parameter values and to perform unsupervised detection of new anomalies at the application 114. In some embodiments, the application 114 may involve detecting anomalies within the same set of data as 102. In other embodiments, the application may involve detecting anomalies within a different set of data than the data 102. The application 114 may be employed to different sets of data when the types of data are similar to the set of data 102. For example, the set of data 102 may be QoS information related to telecommunications service for the month of March. The application 114 may employ the anomaly detection approaches with optimized threshold parameter values to detect anomalies for a set of data that may be QoS information related to a telecommunication services for the month of April. The anomalies and non-anomalies detected by the application 114 may be used generate an inference set of data 116. In some embodiments, the inference set of data 116 may contain the detected anomalies and non-anomalies by the application 114 for the set of data 102. In other embodiments, the inference set of data 116 may contain the detected anomalies and non-anomalies by the application 114 for a different set of data.

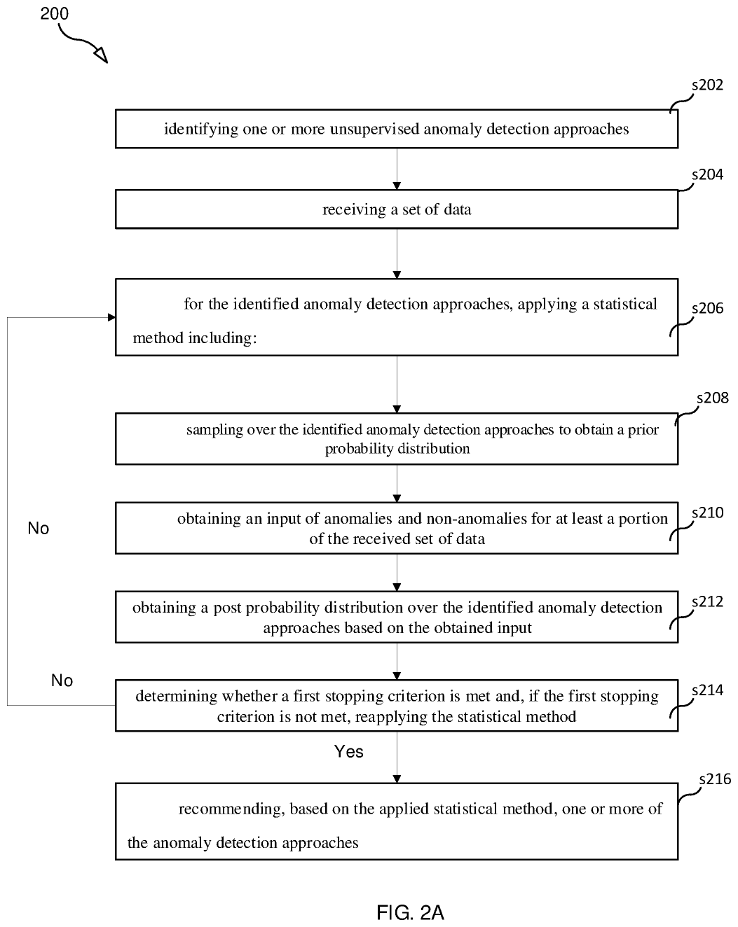

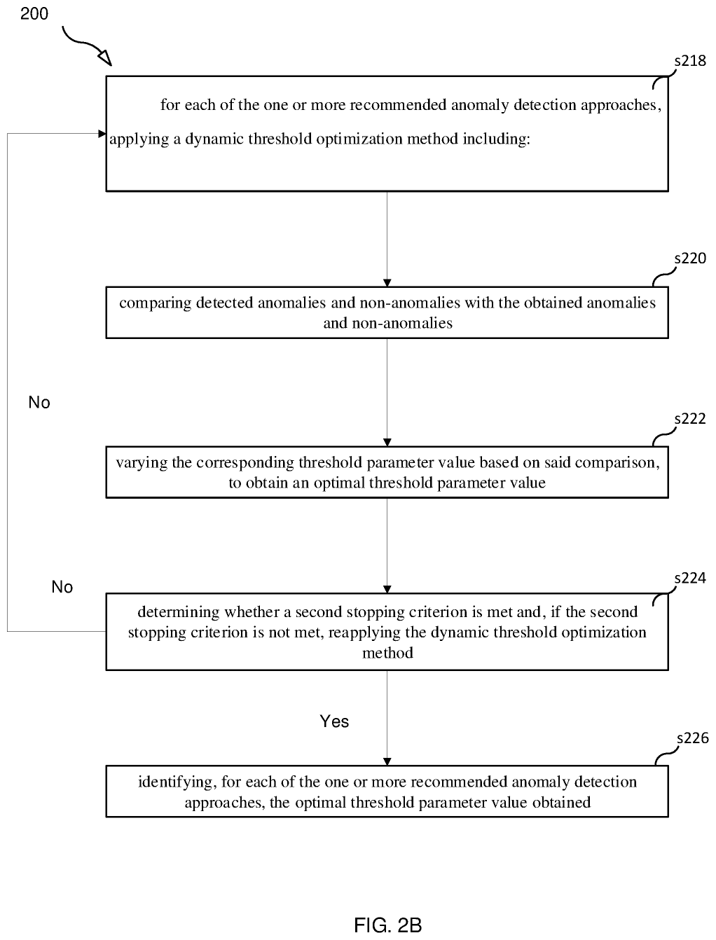

FIG. 2A is a block diagram illustrating a computer-implemented method 200 for unsupervised anomaly detection according to some embodiments. Method 200 may begin with step s202.

Step s202 comprises, identifying one or more unsupervised anomaly detection approaches, wherein each anomaly detection approach identified includes an anomaly detection algorithm and a corresponding initial threshold parameter value; and step s204 comprises receiving a set of data.

Step s206 comprises, for the identified anomaly detection approaches, applying a statistical method including step s208, sampling over the identified anomaly detection approaches to obtain a prior probability distribution; step s210, obtaining an input of anomalies and non-anomalies for at least a portion of the received set of data: step s212, obtaining a post probability distribution over the identified anomaly detection approaches based on the obtained input; and step s214 determining whether a first stopping criterion is met and, if the first stopping criterion is not met, reapplying the statistical method at steps s206 through s214.

Step s216 comprises recommending, based on the applied statistical method, one or more of the anomaly detection approaches.

The method 200 continues with reference to FIG. 2B. Step s218 comprises for each of the one or more recommended anomaly detection approaches, applying a dynamic threshold optimization method including: step s220 comparing detected anomalies and non-anomalies with the obtained anomalies and non-anomalies; step s222 varying the corresponding threshold parameter value based on said comparison, to obtain an optimal threshold parameter value; and step s224 determining whether a second stopping criterion is met and, if the second stopping criterion is not met, reapplying the dynamic threshold optimization method steps s216 through steps s224.

Step s226 comprises identifying, for each of the one or more recommended anomaly detection approaches, the optimal threshold parameter value is obtained.

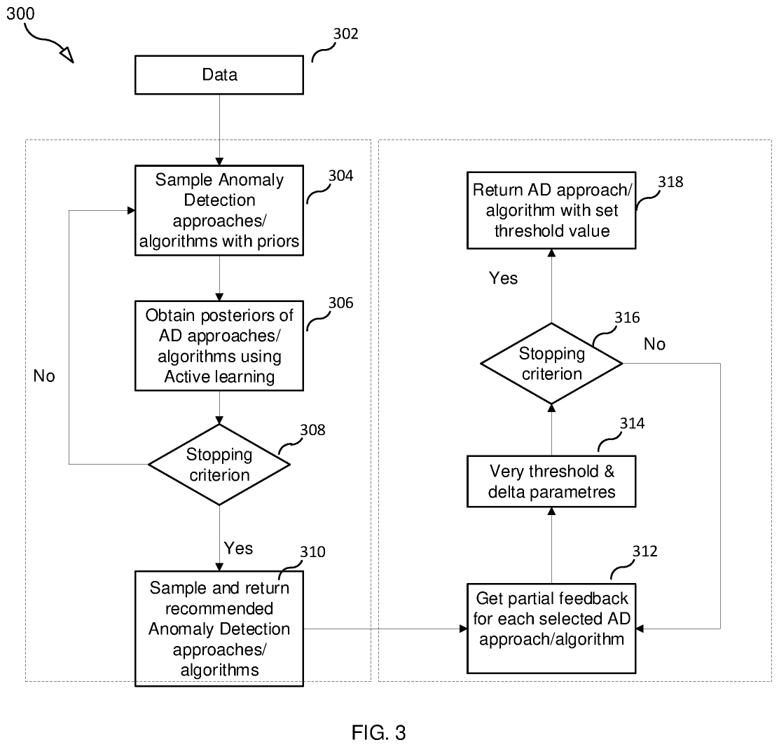

FIG. 3 is a block diagram illustrating a method 300 for unsupervised anomaly detection using a statistical method for recommending anomaly detection approaches and dynamically selecting optimal threshold parameter values for the recommended approaches according to some embodiments. At 302, a data set is available. In some embodiments, the data set may pertain to telecommunications. In further embodiments, the data set may pertain to KPI. In further embodiments, the key performance indicator may relate to QoS. In other embodiments, the key performance indicator may related to QoR.

At 304-308, a statistical method is used to recommend the one or more unsupervised anomaly detection approaches. At 304, unsupervised anomaly detection approaches are sampled by processing the data set to obtain a prior probability distribution over anomaly detection approaches. At 306, a post probability distribution over anomaly detection approaches is obtained. The post probability distribution may be obtained by analyzing the prior probability distribution. Optionally, user inputs may be incorporated while analyzing the prior probability distribution to obtain the post probability distribution. In some embodiments, active learning may be used to obtain inputs of anomalies and non-anomalies identified by the user for at least a portion of the data within the data set 302.

At 308, a first stopping criterion is employed. In some embodiments, the first stopping criterion may be based on a predetermined number of epochs or iterations. In other embodiments the first stopping criterion may be based on m anomaly detection approaches whose post probability values are above a first stopping threshold. If the first stopping criterion is not met, the statistical method employed at 304-308 may be repeated until the first stopping criterion at 308 is met. In some embodiments, once the first stopping criterion is met, the method 300 will return the m recommended anomaly detection algorithms whose post probabilities are above the first stopping threshold at 310. In other embodiments, once the first stopping criterion is met, the method 300 will return a set number of m approaches after the set number of iterations at 310 has been met.

At 312-316, a dynamic threshold optimization method is employed. In some embodiments, the dynamic threshold optimization may follow a continuous optimization. In other embodiments, the dynamic threshold optimization method may follow a reinforcement learning method. In further embodiments, the reinforcement learning method may be a contextual bandit.

At 312, partial feedback is received for each selected anomaly detection approach. The partial feedback may include comparing anomalies and non-anomalies detected by the recommended approaches with the anomalies and non-anomalies obtained, for example, from a user at 306. In some embodiments, a second input identifying anomalies and non-anomalies may be obtained, for example, from a user at 312 in order to perform said comparison. The comparison may show instances in which the recommended approaches are incorrectly identifying anomalies (misclassified) or failing to detect anomalies (missed).

At 314, the corresponding threshold parameter values may be varied. In some embodiments, the rate of change in the corresponding threshold parameter values may also be varied. In some embodiments, the rate of change of the corresponding threshold may be varied based on the partial feedback on the comparison at 312. In some embodiments, the corresponding threshold may be increased if there are more missed than misclassified anomalies. In other embodiments, the corresponding threshold may be increased if a low reward is received, and there is a high number of missed anomalies and a low number of misclassified anomalies. In some embodiments, the corresponding threshold may be decreased if there are more misclassified than missed anomalies. In other embodiments, the corresponding threshold may be decreased if a low reward is received, and there is a high number of misclassified anomalies and a low number of missed anomalies. In some embodiments, the rate of change for the threshold may be dynamically changed based on the number of misclassified and missed anomalies.

At 316, a second stopping criterion is employed. In some embodiments, the second stopping criterion may be the rate of change of the corresponding threshold falling below a second stopping threshold. In other embodiments, the second stopping criterion may be when a high reward is received, and there is no change in the corresponding threshold. If the second stopping criterion is not met, then the dynamic threshold optimization framework at 312-316 is repeated. Once the second stopping criterion is met, the method 300 moves to 318.

At 318, the method 300 returns the one or more anomaly detection approaches with optimized threshold parameter values.

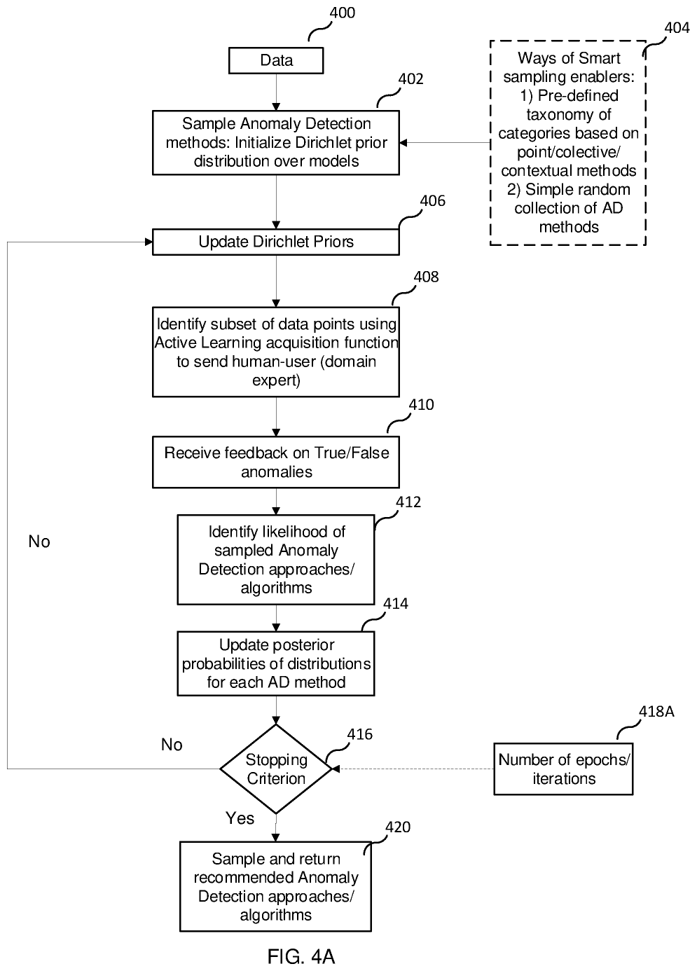

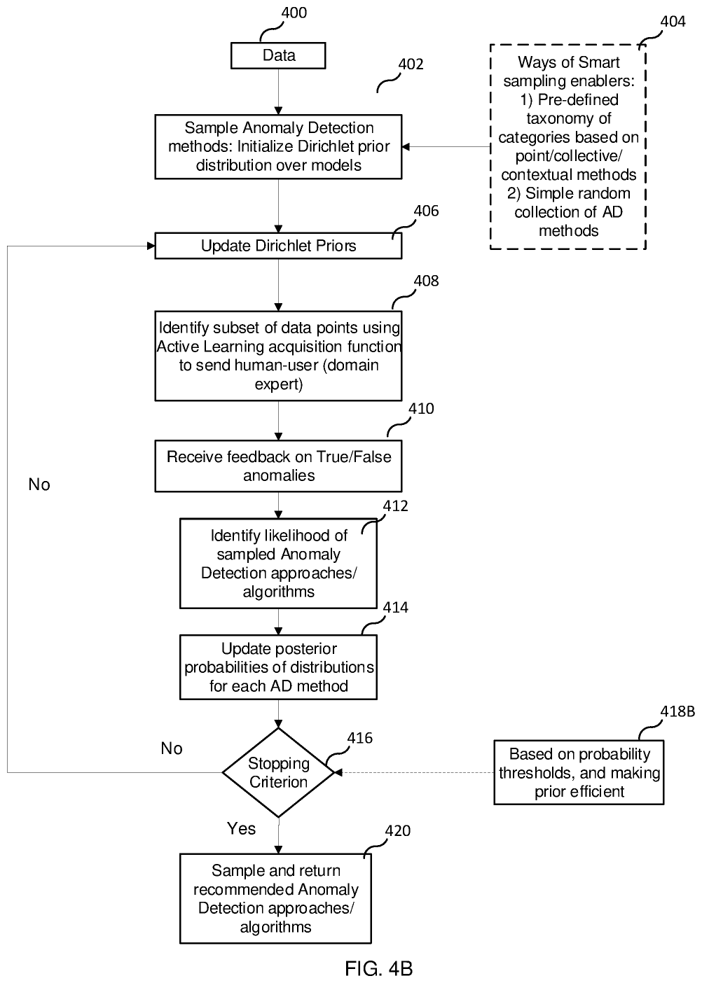

FIG. 4A is a block diagram illustrating a method for unsupervised anomaly detection using a statistical method for recommending anomaly detection approaches according to some embodiments. At 400, a data set is available. At 402, one or more anomaly detection approaches may be selected as possible candidates for unsupervised detection of anomalies. The unsupervised anomaly detection approaches may be sampled in order obtain a prior probability distribution for each of the one or more unsupervised anomaly detection approaches.

At 404, other factors may be incorporated to assign the prior probability distribution. The prior probability distribution may follow different types of distributions. For example, the prior probability distribution may follow a Dirichlet distribution, a Bernoulli distribution, a Nominal distribution, a Binomial distribution, a Multinomial distribution, a Uniform distribution, a T-distribution, a Beta distribution, a Beta-binominal distribution, a Poisson distribution, and a Gaussian distribution. In some embodiments, the selection of anomaly detection approaches may follow a categorical distribution over k anomaly detection methods. The categorical distribution may be denoted by the following equation: Σᵢ₌₁^{k}pᵢ=1. In some embodiments, the prior probability distribution may follow a Dirichlet distribution. The Dirichlet distribution may be distributed with concentrations αᵢ, i=1 . . . k. The prior probability distribution of the categorical distribution may follow the Dirichlet distribution such that pᵢ˜Dir(k, αᵢ), i=1 . . . k.

In some embodiments, there may be known characteristics for the data. The known characteristics may include pre-defined taxonomies of categories for the data. Such pre-defined taxonomies may incorporate information such as the type of anomalies in the data set including whether they are point, contextual, collective anomalies. In some embodiments, a user may provide input on which anomaly detection approaches are most likely to be selected. In other embodiments, such as when no known information is available for the data, the prior probability distribution may follow a uniform distribution. For example, if the prior probability distribution is following a Dirichlet distribution and there are no known characteristics for the data, αᵢ will be set to a uniform value of 1. That is each anomaly detection approach may initially have the same probability of being selected.

At 406-418A, a statistical method may be used to recommend the anomaly detection approaches. In some embodiments, the statistical method may follow a Bayesian inference. In further embodiments, the prior probability distribution may be a Bayesian prior. The method may run through multiple iterations until the stopping criterion at 416 is met.

At 406, the prior probability distribution for each anomaly detection approach for the first iteration is the prior probability distribution found at 402-404. In later iterations, the prior probability distribution is updated to be the post probability distribution found in the previous iteration. In some embodiments, the prior probability distribution may be a Bayesian prior. In further embodiments, the Bayesian prior may be updated with the Bayesian posterior found in the previous iteration.

At 408, a portion of data points within the data set may be selected to gain feedback on. Various data selection methods may be employed. In some embodiments, the data points may be selected entirely at random. In other embodiments, data points may be selected at random for each nearest-neighbor proximity cluster. The selected data points may be transferred to a human user. In further embodiments, active learning may be utilized to receive inputs from the user. The user inputs may identify which of the selected data points are an anomaly and which are a non-anomaly.

At 410, an input from, for example, a user identifying anomalies and non-anomalies may be received.

At 412, the method identifies post probability distribution that may be the likelihood of the sampled anomaly detection approaches being recommended. In some embodiments, the method may update the prior probability distribution to the said post probability distribution based on inputs from the user. The post probability distribution may follow any number of different types of distributions. For example, the post probability distribution could follow a Dirichlet distribution, a Bernoulli distribution, a Nominal distribution, a Binomial distribution, a Multinomial distribution, a Uniform distribution, a T-distribution, a Beta distribution, a Beta-binominal distribution, a Poisson distribution, and a Gaussian distribution. In some embodiments, the post probability distribution will follow a Dirichlet distribution if the prior probability distribution follows a Dirichlet distribution.

At 414, if the method is following a Bayesian inference, the Bayesian posterior may be calculated by weighing the prior probability distribution (or Bayesian prior) with the likelihood of the anomaly detection approaches detecting the anomalies and non-anomalies. The Bayesian posterior may be calculated by the following equation: pᵢ|αᵢ, cᵢ˜Dir(k, αᵢ+cᵢ), ∀i=1 . . . k; where the method follows a Dirichlet distribution denoted by the following equation: αᵢ+cᵢ, i=1 . . . k. In some embodiments, counts cᵢ for occurrences (anomalies and non-anomalies) are calculated for the corresponding anomaly detection approach i.

At 416, the method determines whether a stopping criterion has been met. If the stopping criterion has been met, the method proceeds to 420. If the stopping criterion has not been met, the method will repeat at 406-418A until the stopping criterion is met. When the method repeats, the post probability distribution of the last iteration will become the new prior probability distribution for the next iteration. In some embodiments, the Bayesian posterior of the last iteration will become the new Bayesian prior for the next iteration.

At 418A, an exemplary stopping criterion is shown. The exemplary stopping criterion may be a set number of epochs or iterations. In some embodiments, the method may repeat for the set number of epochs or iterations until the stopping criterion is satisfied. For example, if the stopping criterion is 25 iterations, then 404-418A will go through 25 iterations. The set number of iterations may be predetermined.

At 420, one or more of the anomaly detection approaches are recommended and returned. In further embodiments, a set number of m anomaly detection approaches may be selected in order of highest post probability to lowest post probability. In further embodiments, the anomaly detection approaches may be recommended in order of highest Bayesian posterior probability to lowest Bayesian posterior probability.

In further embodiments, the user may select the set number of m approaches recommended. In other embodiments, the set number m, may be predetermined.

FIG. 4B is a block diagram illustrating a method for unsupervised anomaly detection using a statistical method for recommending anomaly detection approaches according to some embodiments. The block diagram illustrated in FIG. 4B generally follows the same steps as the block diagram illustrated in FIG. 4A, except at 418B.

At 418B, the stopping criterion may be based on probability values. The stopping criterion may be based on m anomaly detection approaches whose post probability values are above a first stopping threshold. The stopping threshold may be predetermined based on known taxonomies for the data set. In some embodiments, the stopping criterion may require a set number of m approaches having post probabilities that are above the first stopping threshold in an iteration.

At 420, in some embodiments, m anomaly detection approaches may be selected based on the m anomaly detection approaches having a post probability that are above a stopping threshold.

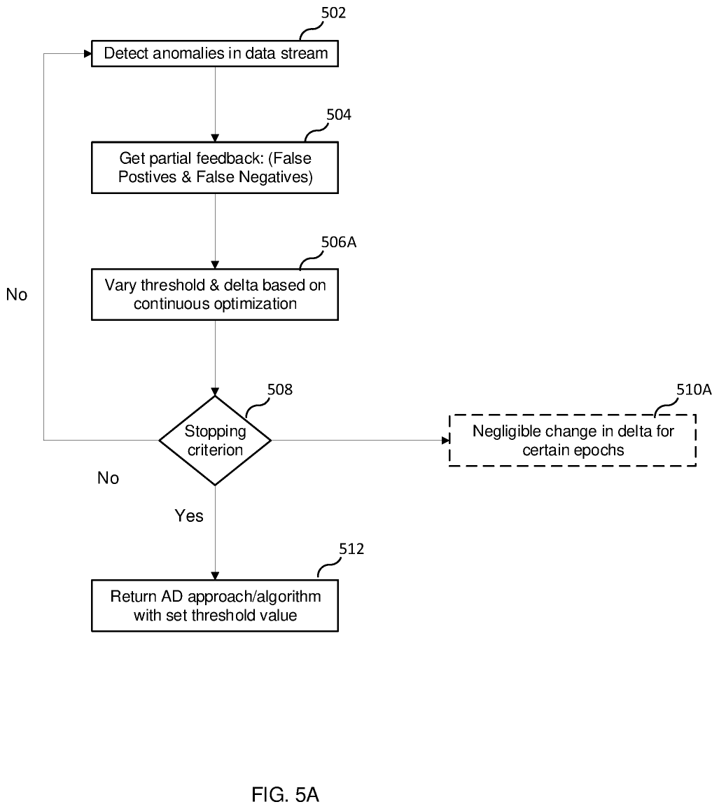

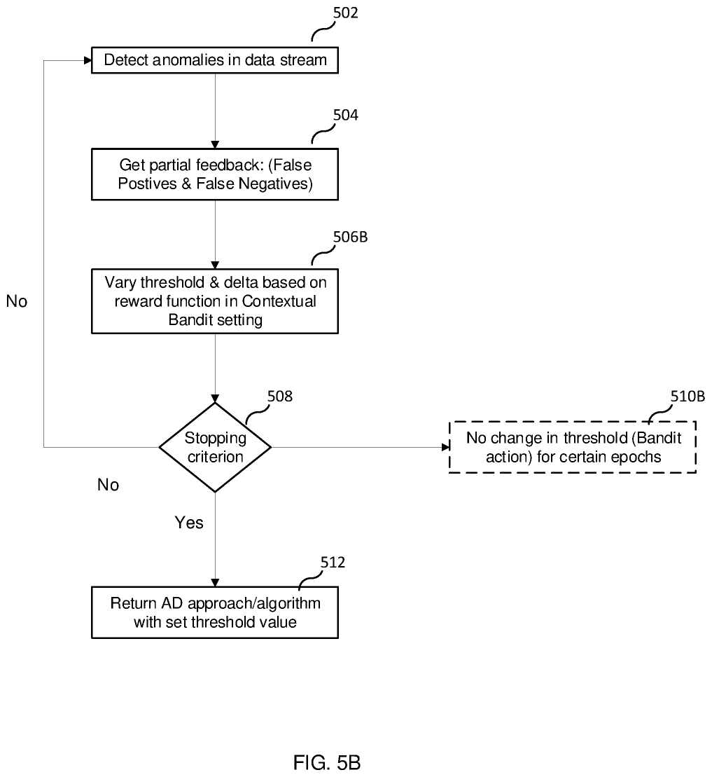

FIG. 5A is a block diagram illustrating a method for unsupervised anomaly detection including dynamically selecting optimal threshold parameter values for the recommended approaches according to some embodiments. The method for dynamically selecting optimal threshold parameter values for the recommended approaches illustrated FIG. 5A is based on continuous optimization.

At 502-510, a dynamic threshold optimization method may be used to optimize the corresponding threshold parameters for the unsupervised anomaly detection approaches. The dynamic threshold optimization method may be repeated until the stopping criterion at 508 is met.

At 502, one or more of the recommended approaches are used to detect anomalies in the set of data. At 504, partial feedback identifying false positives and false negatives may be obtained. As in FIG. 5A, False positives, FP, may be data points within the data set that are incorrectly detected as an anomaly by the one or more recommended approaches when compared to the inputs. False negatives, FN, may be data points within the data set that are incorrectly detected as a non-anomaly by the one or more approaches when compared to the inputs. In some embodiments, a second input may be obtained, for example, from a user identifying anomalies and non-anomalies within the data set from 504 in FIG. 5A. The second input may be used to generate new FP and FN by comparing with anomalies and non-anomalies detected by the recommended approaches.

At 506A, the corresponding threshold parameter values for one or more of the recommended anomaly detection approaches may be varied based on continuous optimization. In continuous optimization, the values for the one or more recommended anomaly detection approaches are continuous variables (as opposed to discrete variables). Continuous optimization may be used in offline settings.

In order to vary the corresponding threshold, a series of calculations may be performed. First, a percentage deviation for the obtained FP and FN for the one or more recommended anomaly detection approaches may be generated. The percentage deviation PD_{FP} may calculate the degree of relative change of FP with respective to FN and may be denoted by the following equation:

$$P {D}_{FP} = abs ( \frac{FP - FN}{FN} ) .$$

The percentage deviation PD_{FN} may calculate the degree of relative change of FN with respect to FP and may be denoted by the following equation:

$$P {D}_{FN} = abs ( \frac{FN - FP}{FP} ) .$$

Next, the maximum percentage deviation between FP and FN, Eta (η) may be calculated by the following equation: η=max(PD_{FP}, PD_{FN}). The range of η may be [0,1].

Next, the change in the threshold parameter value, Delta (∂), may be calculated using a scaled sigmoid function which is squished to the range (0, 1]. ∂ may be calculated by the following equations:

$$\partial = 2 ( \frac{1}{1 + {e}^{- β η}} - 0 \text{.5} ) or \partial = ( \frac{1 - {e}^{- β η}}{1 + {e}^{- β η}} ) .$$

β may govern the change in ∂ and may be in the range of (0, 1], and take a default value of 1. In some embodiments, β may be inversely proportional to window size (w), and acts as a smoothening factor in computing ∂.

Next, if there are more missed anomalies than misclassified, meaning more FN than FP, the threshold will be increased with the calculated ∂ to capture more anomalies. The increase in the threshold may be calculated with the following equation: thresh=thresh+(∇*∂), wherein thresh denotes the threshold parameter value. Nabla (∇) may denote the maximum change that thresh can take. ∇ may be a fixed value in the range [0, 0.1].

If there are more misclassified anomalies than missed anomalies, meaning that the number of FP obtained is greater than the number of FN, the threshold will be decreased by the calculate ∂ to reduce the anomalous misclassification. The decrease in the threshold may be calculated with the following equation: thresh=thresh−(∇*∂).

At 508, a stopping criterion is shown. The threshold variations at 506 may continue repeat until the stopping criterion at 508 is met. At 510A one possible embodiment for the stopping criterion is shown. The stopping criterion may be the change in threshold being lower than a second stopping threshold for an iteration. In some embodiment, the stopping criterion may be denoted by: ∂>ε_{∂}, where ε_{∂} is very small. If the stopping criterion at 508 is not met, 502-508 may repeat until the stopping criterion at 508 is met. Once the stopping criterion at 508 has been met the method proceeds to 512.

At 512, the anomaly detection approaches will be returned with the optimal threshold values obtained.

FIG. 5B is a block diagram illustrating a method for unsupervised anomaly detection including dynamically selecting optimal threshold parameter values for the recommended approaches according to some embodiments. The method for dynamically selecting optimal threshold parameter values for the recommended approaches illustrated FIG. 5B is based on contextual bandit. The block diagram illustrated in FIG. 5B generally follows the same steps as the block diagram illustrated in FIG. 5A, except at 510B.

At 510B, the corresponding threshold parameter value may be varied based on a reinforcement learning method. The reinforcement learning method may be used for online learning scenarios. In some embodiments, the reinforcement learning method may be a contextual bandit. In some embodiments, the contextual bandit may contain states, actions, and reward functions. States may be contextual information that allows decisions to be made based on the state of the environment. An action may be different steps or methods that can be undertaken. A reward function may be the incentive for the program to choose a particular action.

In some embodiments, the states may be defined as thresh, FP, and FN. Actions may be defined as increase thresh, decrease thresh, and no change in thresh. The reward may be defined as a function of ∂. The reward may be denoted by the following equation: Reward=−∂.

In some embodiments, the reward system may be established in the following way in order to vary the corresponding threshold parameter value. If there are a low number of both FP and FN, meaning that the anomalies are successfully being identified by the recommended approach, then ∂→0 and the reward will be high, and there is no change in the corresponding threshold.

In some embodiments, if there is a high number of FP and a low number of FN, then ∂→1 and the reward is low. In some embodiments, determining that there is a high number of FP and a low number of FN may be based on calculating the percentage difference in the amount of FP and FN. In some embodiments, if there is a high FP and a low FN then the corresponding threshold may be decreased in the same manner as at 506 in FIG. 5A.

In some embodiments, if there is a high number of FN and a low number of FP, then ∂→1 and the reward may be low. In some embodiments, determining that there is a high number of FN and a low number of FP may be based on by calculating the percentage difference in the amount of FN and FP. In some embodiments, if there is a high number of FN and a low number of FP, the corresponding threshold may be increased in the same manner as at 506 in FIG. 5A.

In some embodiments, both FP and FN are high, meaning that there are a lot of missed and misclassified anomalies, then ∂→0 and reward will be high, and there is no change in the corresponding threshold.

Whether there is a high number of both FP and FN may be determined by the following equation:

$$error\_rate = \frac{FP + FN}{window\_size} .$$

In some embodiments, if there are a high number of FP and FN, the data set may use an optimal window size. In other embodiments, one or more anomaly detection approaches may be switched to non-linear methods if there are a high number of both false positives and false negatives.

At 508, the method determines whether a stopping criterion has been met. If the stopping criterion has not been met, the dynamic threshold optimization method may be repeated at 502-510.

At 510B, an exemplary stopping criterion is shown. The stopping criterion may be stopping if there is no change for the corresponding threshold parameter value for the anomaly detection approaches.

At 512, the anomaly detection approaches with optimized threshold parameter values are returned.

In some embodiments, the method further comprises using the one or more recommended anomaly detection approaches, each including the recommended anomaly detection algorithm with corresponding optimal threshold parameter value, to detect an anomaly.

In some embodiments, the one or more recommended anomaly detection approaches are used for detecting anomalous behavior in a telecommunications network. The apparatus and method for unsupervised anomaly detection according to some embodiments is in a telecommunications network for centralized monitoring for telecom networks in Network Operations Centers (NOCs) for emerging 5G systems, where Network Function Virtualization (NFV) enables operators to optimize the hardware resources necessary for network application deployment. Network function dimensioning in IP Multimedia Subsystem (IMS) is typically performed based on the historical data from KPIs/PM counters, by monitoring the network behavior and other factors. Here, we consider the particular problem of detecting anomalous behavior of CPU load in Virtual Network Functions (vNFs) to prevent incorrect resource-requirement estimation.

The KPIs/PM counters used for detecting anomalies in CPU load are the following: De-Registrations, Initial Registrations, Re-Registrations, Call Duration, Call Attempts, Answered Calls, Total SMS, etc.

The type/distribution of anomalous data is identified as contextual and unsupervised in nature. This is followed by mapping the same to a taxonomy of various unsupervised anomaly detection algorithms with their respective model priors.

For the current illustration, we consider a total of 6 anomaly detection algorithms—{K_1, K_2, . . . , K_6}—from this taxonomy with the default threshold parameter values initially used for each algorithm. The Dirichlet priors over all the 6 algorithms are first initialized from the given taxonomy using the statistical method disclosed herein with reference to FIG. 4A. A smaller subset of data points is then chosen using the proposed active learning acquisition function for feedback on the points from the domain expert. For instance, let us consider a scenario where De-Registrations are high and Initial Registrations are low, but CPU load remains the same. However, these anomalous points are not necessarily identified by the algorithm, but would accurately be identified by the domain expert. This is followed by updating the Dirichlet posterior probabilities over all the algorithms. This process is repeated over multiple iterations until an effective stopping criterion is reached in accordance with the method of FIG. 4A, as described herein. The top m algorithms (where m is chosen by the end-user) are then sampled from the final posterior model probabilities.

The optimal threshold parameters of these top m recommended algorithms are then dynamically fine-tuned using ∂ as proposed in continuous optimization framework, with reference to FIG. 5A, as described herein. This efficiently converges towards the optimal threshold parameters typically in an offline setting. Furthermore, in online learning scenarios, the threshold parameters can be optimized using a reward-based contextual bandits method, in accordance with the method of FIG. 5B, as described herein.

Once the whole method is executed, the domain expert/end-user monitors the KPI performance and anomalous behavior. Over time, the definition of anomalies in KPIs might change or new KPIs could be added. There might also be a change in the number of vNFs provisioned in that location due to which CPU load and other KPIs' ranges could change accordingly. Such scenarios with evolving nature of anomalous data could be addressed by periodic retraining.

The users have the choice of choosing their own set of initial anomaly detection algorithms. Examples of anomaly detection algorithms along with their corresponding threshold parameters are described above with reference to Table 1. The algorithms are chosen depending on their capabilities to handle univariate and/or multivariate data.

Initially, the anomaly detection apparatus and method recommends the top m approaches. This is followed by fine-tuning their respective threshold parameters. Here, we consider the top 2 recommended approaches—Isolation Forest and Local Outlier Factor, and their respective threshold parameters are fine-tuned. The final accuracies for Isolation Forest and Local Outlier Factor are 96% and 94.5%, and are benchmarked against domain expert's feedback.

In some embodiments, the received set of data relates to a key performance indicator (KPI). In some embodiments, the key performance indicator relates to quality of service (QoS). In some embodiments, the key performance indicator relates to quality of reception (QoR).

In some embodiments, the statistical method follows Bayesian inference. In some embodiments, the prior probability distribution is a Bayesian prior. In some embodiments, the post probability distribution is a Bayesian posterior. In some embodiments, the prior probability distribution follows one of: a Dirichlet distribution, a Bernoulli distribution, a Nominal distribution, a Binomial distribution, a Multinomial distribution, a Uniform distribution, a T-distribution, a Beta distribution, a Beta-binominal distribution, a Poisson distribution, and a Gaussian distribution.

In some embodiments, if known characteristics of the received set of data are available, the prior probability distribution is based on the known characteristics, and if not available, the prior probability distribution is uniform. In some embodiments, the known characteristics of the received set of data includes at least one of: point type anomalies, contextual type anomalies, and collective type anomalies.

In some embodiments, the prior probability distribution is based on a user input. In some embodiments, the input of anomalies and non-anomalies obtained is user-generated. In some embodiments, an active learning acquisition function is used for obtaining the input of anomalies and non-anomalies.

In some embodiments, the post probability distribution follows one of: a Dirichlet distribution, a Bernoulli distribution, a Nominal distribution, a Binomial distribution, a Multinomial distribution, a Uniform distribution, a T-distribution, a Beta distribution, a Beta-binominal distribution, a Poisson distribution, and a Gaussian distribution.

In some embodiments, the post probability distribution is updated based on the prior probability distribution and the input on anomalies and non-anomalies obtained.

In some embodiments, the first stopping criterion is based on a predetermined number of iterations after which m anomaly detection approaches are recommended. In some embodiments, the first stopping criterion is based on m anomaly detection approaches whose post probability values are above a first stopping threshold, and the said m anomaly detection approaches are recommended.

In some embodiments, the dynamic threshold optimization method follows a continuous optimization. In some embodiments, the dynamic threshold optimization method further includes: obtaining a second input of anomalies and non-anomalies for at least a portion of the received set of data; and comparing detected anomalies and non-anomalies with the obtained second input of anomalies and non-anomalies. In some embodiments, false positives and false negatives are obtained by said comparison. In some embodiments, the dynamic threshold optimization method further includes: varying the corresponding threshold parameter value based on a percentage deviation as compared to the false positives and false negatives obtained. In some embodiments, the corresponding threshold parameter value is increased if there are more false negatives than false positives. In some embodiments, the corresponding threshold parameter value is decreased if there are more false positives than false negatives.

In some embodiments, the second stopping criterion is based on a change in corresponding threshold parameter value being lower than a second stopping threshold.

In some embodiments, the dynamic threshold optimization method follows a contextual bandit. In some embodiments, a high reward is received and no change is made to the corresponding threshold parameter value if the number of both false positives and false negatives is low. In some embodiments, a low reward is received and the corresponding threshold parameter value is increased if the number of false negatives is greater than the number of false positives. In some embodiments, a low reward is received and the corresponding threshold parameter value is decreased if the number of false positives is greater than the number of false negatives. In some embodiments, a high reward is received and the corresponding threshold parameter value is unchanged if the number of both false positives and false negatives is high.

In some embodiments, the received set of data uses an optimal window size if there are a high number of both false positives and false negatives.

In some embodiments, one or more anomaly detection approaches are switched to non-linear methods if there are a high number of both false positives and false negatives.

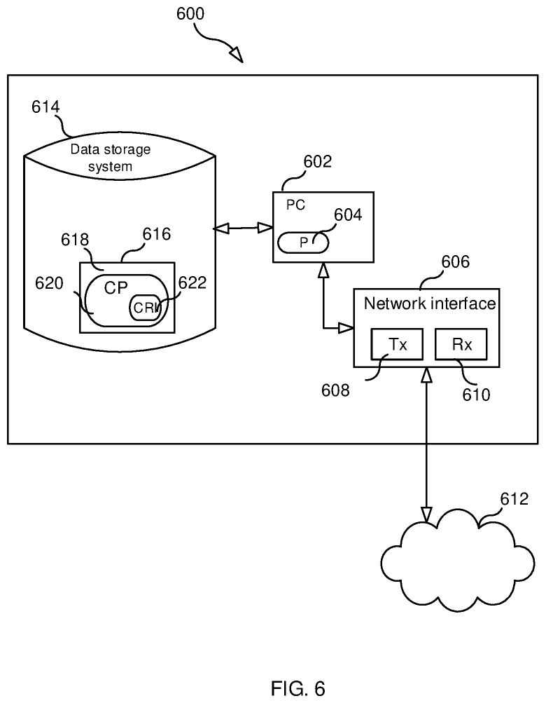

FIG. 6. is a block diagram of an apparatus 600 (e.g., a network node, connected device, and the like), according to some embodiments. As shown in FIG. 6, the apparatus may comprise: processing circuitry (PC) 602, which may include one or more processors (P) 604 (e.g., a general purpose microprocessor and/or one or more other processors, such as an application specific integrated circuit (ASIC), field-programmable gate arrays (FPGAs), and the like); a network interface 606 comprising a transmitter (Tx) 608 and a receiver (Rx) 610 for enabling the apparatus to transmit data to and receive data from other computing devices connected to a network 612 (e.g., an Internet Protocol (IP) network) to which network interface 606 is connected; and a local storage unit (a.k.a., “data storage system”) 614, which may include one or more non-volatile storage devices and/or one or more volatile storage devices. In embodiments where PC 602 includes a programmable processor, a computer program product (CPP) 616 may be provided. CPP 616 includes a computer readable medium (CRM) 618 storing a computer program (CP) 620 comprising computer readable instructions (CRI) 622. CRM 618 may be a non-transitory computer readable medium, such as, magnetic media (e.g., a hard disk), optical media, memory devices (e.g., random access memory, flash memory), and the like. In some embodiments, the CRI 622 of CP 2320 is configured such that when executed by PC 602, the CRI 622 causes the apparatus 600 to perform steps described herein (e.g., steps described herein with reference to the block diagrams). In other embodiments, the apparatus may be configured to perform steps described herein without the need for code. That is, for example, PC 602 may consist merely of one or more ASICs. Hence, the features of the embodiments described herein may be implemented in hardware and/or software.

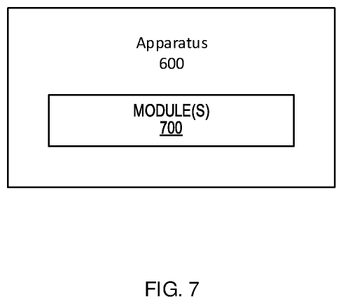

FIG. 7. is a schematic block diagram of the apparatus 600 according to some other embodiments. The apparatus 600 includes one or more modules 700, each of which is implemented in software. The module(s) 700 provide the functionality of apparatus 600 described herein (e.g., steps described herein).

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A computer-implemented method for unsupervised anomaly detection, the method comprising:
identifying one or more unsupervised anomaly detection approaches, wherein each anomaly detection approach identified includes an anomaly detection algorithm and a corresponding threshold parameter value;
receiving a set of data;
for the identified anomaly detection approaches, applying a statistical method including:
sampling over the identified anomaly detection approaches to obtain a prior probability distribution;
obtaining an input of anomalies and non-anomalies for at least a portion of the received set of data;
obtaining a post probability distribution over the identified anomaly detection approaches based on the obtained input, wherein the post probability distribution updates the prior probability distribution; and
determining whether a first stopping criterion is met and, if the first stopping criterion is not met, reapplying the statistical method;
recommending, based on the applied statistical method, one or more of the anomaly detection approaches;
for each of the one or more recommended anomaly detection approaches, applying a dynamic threshold optimization method including:
comparing detected anomalies and non-anomalies with the obtained anomalies and non-anomalies;
varying the corresponding threshold parameter value based on said comparison, to obtain an optimal threshold parameter value; and
determining whether a second stopping criterion is met and, if the second stopping criterion is not met, reapplying the dynamic threshold optimization method; and
identifying, for each of the one or more recommended anomaly detection approaches, the optimal threshold parameter value obtained.

2. The method according to claim 1, further comprising using the one or more recommended anomaly detection approaches, each including the recommended anomaly detection algorithm with corresponding optimal threshold parameter value, to detect an anomaly.

3. The method according to claim 1, wherein the one or more recommended anomaly detection approaches are used for detecting anomalous behavior in a telecommunications network.

4. The method according to claim 1, wherein the received set of data relates to a key performance indicator (KPI).

5-6. (canceled)

7. The method according to claim 1, wherein the statistical method follows Bayesian inference, the prior probability distribution is a Bayesian prior, and/or the post probability distribution is a Bayesian posterior.

8-9. (canceled)

10. The method according to claim 1, wherein the prior probability distribution and or the post probability distribution follows one of: a Dirichlet distribution, a Bernoulli distribution, a Nominal distribution, a Binomial distribution, a Multinomial distribution, a Uniform distribution, a T-distribution, a Beta distribution, a Beta-binominal distribution, a Poisson distribution, and a Gaussian distribution.

11. The method according to claim 1, wherein, if known characteristics of the received set of data are available, the prior probability distribution is based on the known characteristics, and if not available, the prior probability distribution is uniform.

12-17. (canceled)

18. The method according to claim 1, wherein the first stopping criterion is based on a predetermined number of iterations after which m anomaly detection approaches are recommended.

19. The method according to claim 1, wherein the first stopping criterion is based on m anomaly detection approaches whose post probability values are above a first stopping threshold, and the said m anomaly detection approaches are recommended.

20. (canceled)

21. The method according to claim 1, wherein the dynamic threshold optimization method further includes:
obtaining a second input of anomalies and non-anomalies for at least a portion of the received set of data; and
comparing detected anomalies and non-anomalies with the obtained second input of anomalies and non-anomalies.

22. The method according to claim 1, wherein one or more false positives and false negatives are obtained by said comparison.

23. The method according to claim 22, wherein the dynamic threshold optimization method further includes: varying the corresponding threshold parameter value based on a percentage deviation as compared to the false positives and false negatives obtained.

24. The method according to claim 22, wherein the corresponding threshold parameter value is increased if there are more false negatives than false positives.

25. The method according to claim 22, wherein the corresponding threshold parameter value is decreased if there are more false positives than false negatives.

26-27. (canceled)

28. The method according to claim 22, wherein a high reward is received and no change is made to the corresponding threshold parameter value if the number of both false positives and false negatives is low.

29. The method according to claim 22, wherein a low reward is received and the corresponding threshold parameter value is increased if the number of false negatives is greater than the number of false positives.

30. The method according to claim 22, wherein a low reward is received and the corresponding threshold parameter value is decreased if the number of false positives is greater than the number of false negatives.

31. The method according to claim 22, wherein a high reward is received and the corresponding threshold parameter value is unchanged if the number of both false positives and false negatives is high.

32-33. (canceled)

34. A apparatus for unsupervised anomaly detection comprising:
processing circuitry; and
a memory, said memory containing instructions executable by said processing circuitry, whereby said apparatus is operative to:
identify one or more unsupervised anomaly detection approaches, wherein each anomaly detection approach identified includes an anomaly detection algorithm and a corresponding threshold parameter value;
receive a set of data;
for the identified anomaly detection approaches, applying a statistical method including:
sample over the identified anomaly detection approaches to obtain a prior probability distribution;
obtain an input of anomalies and non-anomalies for at least a portion of the received set of data;
obtain a post probability distribution over the identified anomaly detection approaches based on the obtained input, wherein the post probability distribution updates the prior probability distribution; and
determine whether a first stopping criterion is met and, if the first stopping criterion is not met, reapplying the statistical method;
recommend, based on the applied statistical method, one or more of the anomaly detection approaches;
for each of the one or more recommended anomaly detection approaches, apply a dynamic threshold optimization method including:
compare detected anomalies and non-anomalies with the obtained anomalies and non-anomalies;
vary the corresponding threshold parameter value based on said comparison, to obtain an optimal threshold parameter value; and
determine whether a second stopping criterion is met and, if the second stopping criterion is not met, reapplying the dynamic threshold optimization method; and
identifying, for each of the one or more recommended anomaly detection approaches, the optimal threshold parameter value obtained.

35. (canceled)

36. A computer program product comprising a non-transitory computer readable medium storing a computer program comprising instructions which, when executed on processing circuitry, cause the processing circuitry to perform the method of claim 1.

37. (canceled)
